(19) United States
(12) Patent Application Publication
(10) Pub. No.: US 2004/0261558 A1
(43) Pub. Date: Dec. 30, 2004

(54) Transmission output shaft

(76) Inventor: Scott Austin, Painted Post, NY (US)

Correspondence Address: Frank A. LaViola, Jr., Cameron Fabricating Corporation, P.O. Box 478, Horseheads, NY, 14845, US

(21) Appl. No.: 10/881,849

(22) Filed: Jun. 30, 2004

Related U.S. Application Data
(60) Provisional application No. 60/483,978, filed on Jun. 30, 2003.

(51) Int. Cl. F16H 55/00

(52) U.S. Cl. 74/431

(57) ABSTRACT

The present invention is a transmission output shaft that combines a splined or keyed shaft and a yoke or cv-joint into a single unitary shaft. This combination makes for a longer axial length than a separate, individual shaft and yoke arrangement. The simplistic design and unitary construction makes for easy modification of the existing two-part shaft and yoke. The conventional shaft and yoke are removed and replaced with the unitary differential output shaft of the present invention. Various seals and bearing may or may not be used to enhance the overall performance and increase the life span of the jointed area. Due to its simple design and decreased number of parts, the present invention is more cost effective, has a greater reliability and reduces assembly cost because of its ease of installation.

### RELATED APPLICATIONS

This application is related to provisional application 60/483,978 filed on Jun. 30, 2003.

### BACKGROUND OF THE INVENTION

(1) Field of the Invention

The present invention relates to a transmission output shaft for all-terrain vehicles, golf cars, utility vehicles and the like. The transmission output shaft of the present invention was developed to solve a need for a low cost and highly reliable shaft and yoke combination that does not exist today. It will be shown how the present invention is an improvement over the existing shaft arrangements cited below. The basic idea behind the invention is to provide a shaft and yoke type of a unitary construction for directly coupling the transmission to a drive shaft or half shaft. This would eliminate the need for a shaft that extends outside of the transmission, external housing and external bearing. The transmission output shaft of the present invention also serves to eliminate parts, decrease manufacturing and assembly costs and provides a longer overall length that helps compensate for any angular misalignment. Reducing the degree of misalignment will lead to longer life of the joint and is a more cost effective option than what exists today. Maintenance costs are low due the fact that you have to replace the joint areas less often and the replacement of the joint area is faster because of the simplistic design.

(2) Description of Related Art

Several patents touched on the subject of shaft arrangements but only the most pertinent will be discussed. U.S. Pat. No. 5,911,286 to Boutin attempts to solve the problem of shaft and yoke interconnection but fails in that there is no way to retain the two parts as shown. Boutin's device is unable to be manufactured as shown and furthermore, Boutin does not combine the shaft and yoke. The shaft and yoke are separate pieces. There are also no sealing or bearing supports shown. The failures of Boutin are exactly the object of the present invention. Other patents such as U.S. Pat. Nos. 6,533,060 and 6,250,415 to Seto and U.S. Pat. No. 5,916,055 to Wormbaecher show other configurations but all fall short of solving the problems as stated above.

### SUMMARY OF THE INVENTION

The present invention solves numerous problems that exist in current shaft and yoke arrangements in the field of all-terrain vehicles, golf cars and utility vehicles. Currently, the length from the differential and transmission/transaxle to the wheel hub is short. The output shaft of the present invention increases this distance and makes the connection angle less severe. By making the connection angle less severe, misalignment is improved and thus, joint life is increased. Combining the differential, transmission/transaxle output shaft with a cv-joint or yoke type connection, the overall axial length of the shaft is increased. This is the major reason for the increase in joint life and reduced maintenance costs. By combining the shaft and yoke into a single piece, there are fewer parts to worry about and assembly time is greatly reduced. Fewer parts mean fewer problems and thus a more reliable product.

Existing arrangements of a shaft, gear and differential housing all rotate together at the same speed. The present invention allows for relative motion between the gear and shaft/yoke but they do not necessarily rotate at the same speed as the differential housing.

### BRIEF DESCRIPTION OF THE DRAWINGS

The present invention will be described in detail with reference made to the following drawings.

FIG. 1 shows the shaft and yoke of the present invention.

FIG. 2 shows the shaft of the present invention installed into a conventional transmission/transaxle housing, differential housing and gear arrangement.

FIG. 3 is similar to FIG. 2 except that the differential housing extends for the full length of the shaft.

FIG. 4 incorporates a thrust bearing into the assembly and shows a stepped down shaft length to accommodate various configurations of parts.

FIG. 5 shows a sleeve/needle bearing positioned between the shaft and differential housing to increase the life of the assembly.

### DETAILED DESCRIPTION OF THE INVENTION

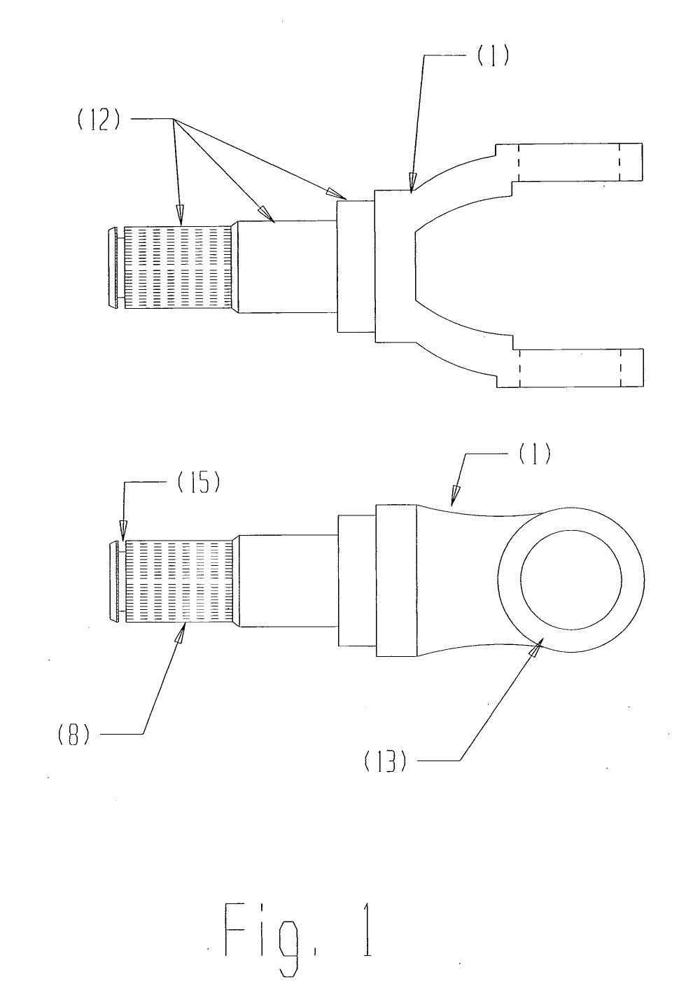

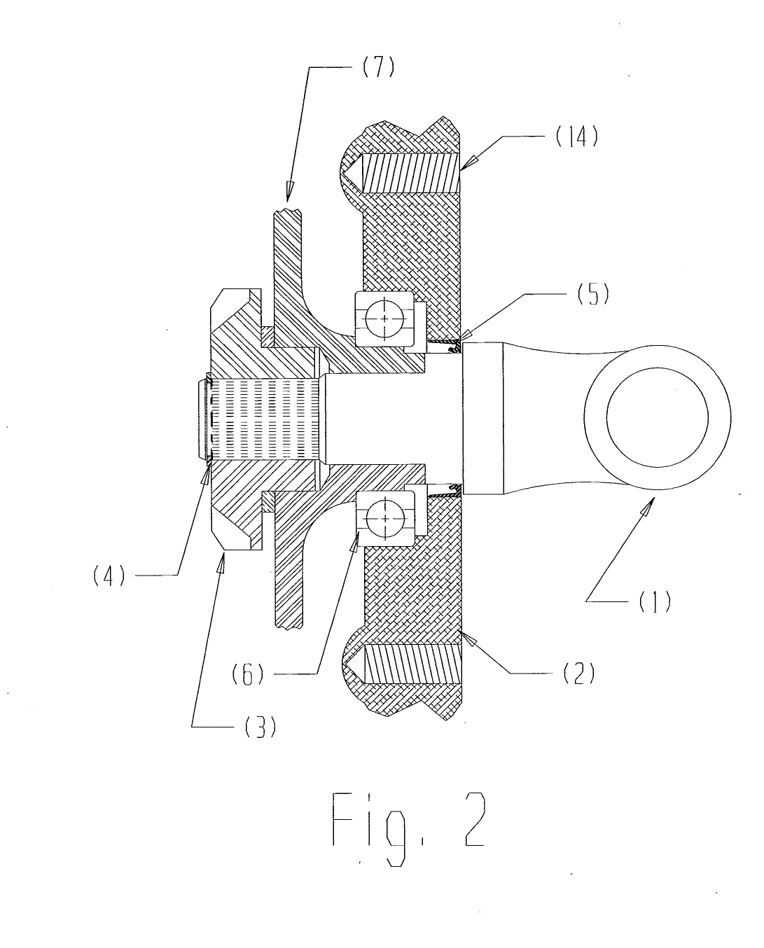

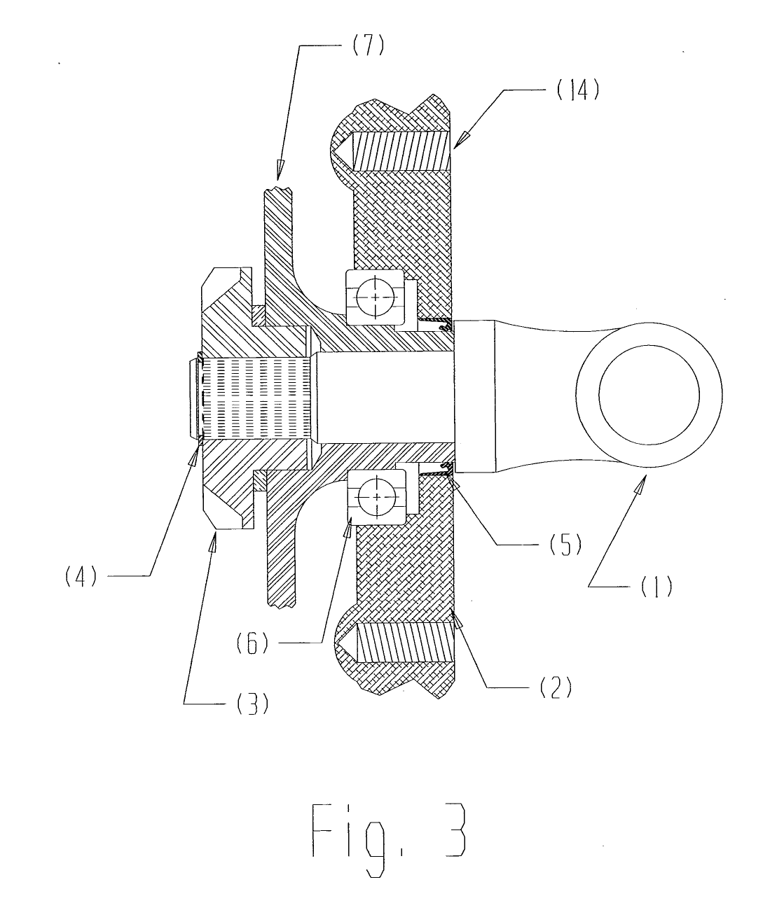

In the drawings, FIG. 1 shows the transmission output shaft of the present invention. The output shaft 1 has an output end 13 at one end and splines 8 at the other end. The axial length of the shaft 1 forms an elongated shaft with the output end or yoke portion 13 at one end and the splines 8 at the other end. This area adjacent the splines 8 form a gear interface area. This gear interface area will be discussed in more detail later. Adjacent the splines 8 is a retaining ring groove 15 that will receive retaining ring 4. See FIG. 2. The splines 8 and the central portion of the shaft may have hardened surfaces 12 to make them last longer and be more resistant to wear over time. The shaft of FIG. 1. replaces the existing shaft and yoke of a conventional arrangement. Once replaced, the new transmission output shaft 1 of the present invention provides a longer axial length to lessen the angle of attachment and reduce the likelihood of misalignment. The transmission output shaft 1 is of unitary construction and can be made of hardened alloy steel or any other suitable material that will provide the strength necessary to perform the intended function. At the output end 13 one would attach a drive shaft or half shaft (not shown) by any of the conventional means. It should be known that the splines 8 can also be a keyed area, square shaped or hex shaped and the inventive concept would not be compromised. The area formed by the splines 8 is the gear interface area, which engages a differential gear 3. The main point in this area is that positive engagement between the shaft 1 and differential gear 3 is achieved. In FIG. 2, the output shaft 1 of the present invention is shown installed in a typical drive arrangement. The original shaft and yoke are removed as evidenced by the remaining mounting holes 14 which will go unused in the new shaft and yoke arrangement as shown. The output shaft 1 of the present invention is attached to differential gear 3 by means of a retaining ring 4 that is positioned in retaining ring groove 15 (See FIG. 1). The gear 3 is attached to the differential housing 7 and the splined surface 8 positively engages the inside of gear 3 to effect a driving action. In FIG. 2 it is clear that the shaft's hardened areas 12 run directly on the inside surface of the bore of the differential housing 7. This arrangement, while adequate, will cause the most wear on the shaft and bore of the differential housing 7. Bearing 6 is positioned between the differential housing 7 and the transmission/transaxle housing 2. Optional seal 5 is shown to keep debris and foreign matter from entering the engagement zones and causing premature wear. While seal 5 is not a required element for the functioning of the assembly, it would be beneficial in helping retain lubricating fluids and in keeping debris from entering the critical engagement areas. Since the seal 5 is also shown in FIGS. 3, 4 and 5, it will not be discussed further since its function is the same in all arrangements.

Turning now to FIG. 3, this arrangement is essentially the same as is shown in FIG. 2 except the bore of the differential housing 7 extends the entire length of the hardened shaft area 12. This arrangement provides more support since there is greater surface contact of the shaft 1 and differential housing 7 than in FIG. 2. In this arrangement the engagement area between differential housing 7 and shaft area 12 acts as a sealing surface as well as a support area.

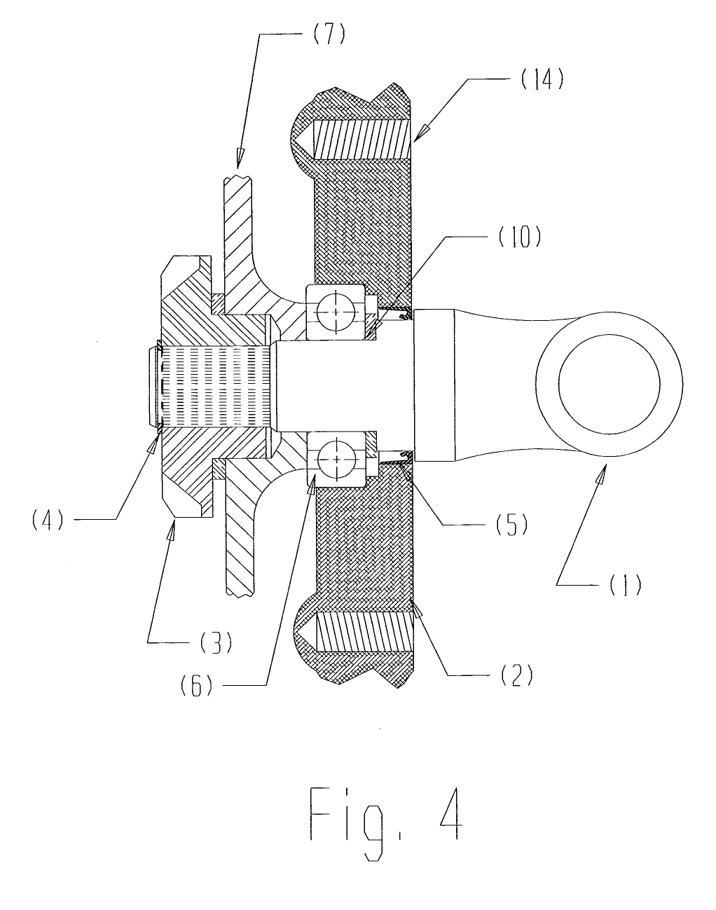

With regards to FIG. 4, the difference here is that the bearing 6 is positioned so as to be in direct contact with the hardened sections 12 of the shaft 1. Also, thrust-bearing 10 is shown to further enhance the operation of the assembly. The hardened sections 12 of the output shaft are shown to have a stepped down in diameter to receive the bearing 6.

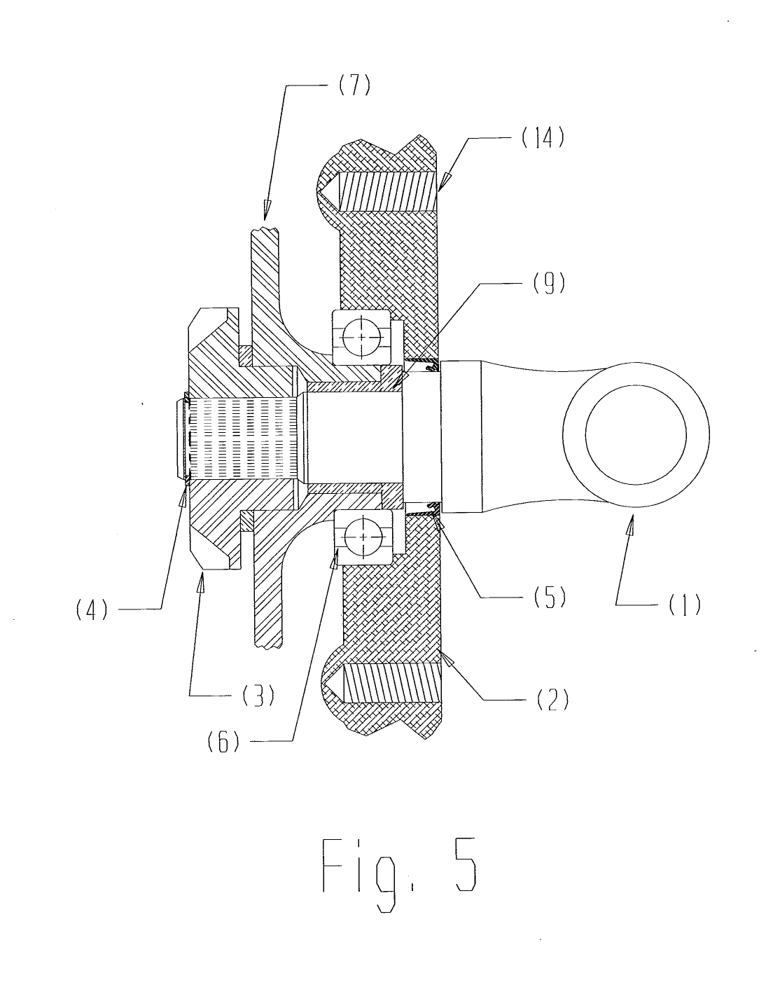

FIG. 5 shows an arrangement similar to FIG. 2 except that the hardened sections 12 are again shown to be stepped down in diameter to receive a different style of bearing than the one shown in FIG. 4. Sleeve or needle bearing 9 is shown which is in direct contact with the shaft surfaces 12 as opposed to FIG. 4 where the shaft 1 runs directly on the differential housing 7. This sleeve or needle bearing 9 can also support axial thrust loads and therefore thrust-bearing 10 is not needed.

It should be made clear that while many of the above items such as seals and optional bearings enhance the performance and longevity of the present invention, they are not required elements in the functioning of the transmission output shaft of the present invention. Also, the optional bearings can be incorporated into the unitary construction if desired and is well within the inventive concept of the present invention.

I claim:

1. A transmission output shaft comprising:
an elongated shaft having an axial length, said elongated shaft having a first end and a second end;
a yoke portion located at said first end of said elongated shaft;
a gear interface surface located at said second end of said elongated shaft; said yoke portion and said gear interface surface being on opposite ends of said elongated shaft; and
a retaining ring groove located at the end of said gear interface surface for receiving a retaining ring, said yoke portion, said gear interface surface and said retaining ring groove being of unitary construction and formed of a single piece whereby said output transmission shaft is capable of providing support for a differential housing and provides an axial thrust surface.

2. A transmission output shaft according to claim 1, said transmission output shaft further comprising:
splines located along said gear interface surface to positively engage an interior surface of a gear.

3. A transmission output shaft according to claim 1, said transmission output shaft further comprising:
said gear interface surface is hex shaped to positively engage an interior surface of a gear.

4. A transmission output shaft according to claim 1, said transmission output shaft further comprising:
said gear interface surface is keyed to positively engage an interior surface of a gear.

5. A transmission output shaft according to claim 1, said transmission output shaft further comprising:
said gear interface surface is square shaped to positively engage an interior surface of a gear.

6. A transmission output shaft according to claim 1, said transmission output shaft further comprising:
sealing means located along said elongated shaft to retain fluids and keep foreign particles from entering the axial length of said elongated shaft.

7. A transmission output shaft according to claim 1, said transmission output shaft further comprising:
hardened surfaces located along at least said gear interface surface and along said axial length of said elongated shaft whereby said hardened surfaces increase said transmission output shaft's resistance to wear.

8. A transmission output shaft according to claim 1, said transmission output shaft whereby;
said elongated shaft has varying diameters along its axial length to accommodate various size and shapes of differential housings and bearings.
